(19) United States
(12) Patent Application Publication
(10) Pub. No.: US 2002/0054014 A1
(43) Pub. Date: May 9, 2002

(54) Multi-function switch device

(75) Inventors: Hiroshi Nishiyama, Shizuoka (JP); Fumie Mukasa, Shizuoka (JP)

Correspondence Address: ARMSTRONG,WESTERMAN & HATTORI, LLP, 1725 K STREET, NW., SUITE 1000, WASHINGTON, DC, 20006, US

(73) Assignee: YAZAKI CORPORATION, Tokyo (JP)

(21) Appl. No.: 09/880,892

(22) Filed: Jun. 15, 2001

(30) Foreign Application Priority Data
Jun. 19, 2000 (JP) 2000-182716

(51) Int. Cl. G09G 5/00

(52) U.S. Cl. 345/156

(57) ABSTRACT

In a multi-function switch device, an initial-level-display executing means 3a-1 causes a display means to display an initial level display image containing a specified function display image for specifying the target appliance. A next-level-display executing means 3a-2 causes the display means to display, in place of the initial level display image, a next level display image containing an operation function display image for selecting operation contents of the target appliance corresponding to the specified function display image when the function display image corresponding to the operation button of a detected operation is a specified function display image. A click-display executing means 3a-3 causes the display means to display a click display image indicative of that the operation button is operated when the operation of the operation button is detected by the operation detecting means. The multi-function switch device can perform or recognize a plurality of functions by each of a plurality of operation buttons when the number of operation buttons as well as the space required for display of the functions are reduced.

### BACKGROUND OF THE INVENTION

1. Field of the Invention

The present invention relates to a multi-function switch device, and more particularly to a multi-function switch device that is commonly used for selecting operation contents of a plurality of object appliances.

2. Description of the Related Art

Electric appliances such as a car stereo, a car air conditioner, etc. which are arranged intensivelyon the console of an motor car, requires operation buttons for selecting the corresponding operations. Conventionally, these operation buttons were individually arranged on the center console for each electric appliance.

However, with a development of technology, each electric appliance had a wide variety of functions which require the corresponding number of operation buttons. Therefore, it has become difficult to arrange all the operation buttons on the center console in a limited space. Further, an increase in the number of the operation buttons might impair the appearance in design of the center console.

In order to obviate such inconveniences, a large number of prior arts have been proposed. Now, an explanation will be given of its typical example, the clustered switch device for a vehicle disclosed in JP-A-59-57043 (Laid-open).

In this concentrated switch device for a vehicle, a plurality of switches for mode selection are indicated on a partial area on a liquid crystal display. In operation, when a mode is selected by touching the indication of either switch by a finger, another transparent switch detects this. Thus, a plurality of switches for function selection corresponding to the selected mode are prepared in another area on the display.

In the clustered switch device, since the switches for function selection are prepared through the operation of the switches for mode selection, the number of switches for function selection to be displayed simultaneously and that of transparent switches for detecting their operation can be reduced.

However, since the areas for the switches for mode selection and function selection are located individually on the liquid crystal display, spaces corresponding to them must be assured on the display, and the respective transparent switches for detecting the operation of the above switches for mode selection and function selection must be provided. It was difficult to arrange these switches in the limited space such as the center console.

In view of the circumstances described above, the present invention has been accomplished.

### SUMMARY OF THE INVENTION

An object of the present invention is to provide a multi-function switch device which can perform or recognize a plurality of functions by each of a plurality of operation buttons when the number of operation buttons as well as the space required for display of the functions are reduced.

In order to attain the above object, in accordance with this invention, as seen from FIG. 1 which shows a conceptual view of this invention, there is provided a multi-function switch device comprising:

a plurality of operation buttons 15a-15h for selecting operation contents of a target appliance, the operation buttons being made of a light permeable member;

display means 15j on which function images representative of functions of the operation buttons are displayed, the function display images being visually recognized through the corresponding operation buttons;

initial-level-display executing means 3a-1 for displaying an initial level display image containing a specified function display image for specifying the target appliance;

means 16a-16h for detecting the operation of each the operation buttons;

next-level-display executing means 3a-2 for displaying, on the display means, in place of the initial level display image, a next level display image containing an operation function display image for selecting operation contents of the target appliance corresponding to the specified function display image when the function display image corresponding to the operation button of the detected operation is the specified function display image; and

click-display executing means 3a-3 for displaying a click display image indicative of that the operation button is operated when the operation of the operation button is detected by the operation detecting means.

In this configuration, by operating the operation button from which a specified function image is visually recognized so that the display is switched from the initial level display image to the next level display image, specifying the target appliance and the selecting the operation contents of the specified can be executed by the same button. In addition, when the operation by the operation button is detected by the click display executing means, the click display image indicative of this fact is displayed so that a user can be visually informed of that the operation button has become valid.

Preferably, the click display executing means displays the click display image permitting the operated operation button to be discriminated from other operation buttons.

In this configuration, when the click display image which is different from that of the operation button operated by the user himself is displayed, the user can recognize his erroneous operation.

Preferably, the click display image is visually recognized through the operated operation button. In this configuration, the operated operation button can be easily discriminated from other operation buttons.

The above and other objects and features of the present invention will be more apparent from the following description taken in conjunction with the accompanying drawings.

### BRIEF DESCRIPTION OF THE DRAWINGS

FIG. 1 is a block diagram of a basic configuration of the multi-function switch device according to the present invention;

FIG. 2 is a front view of the switch device according to the present invention;

FIG. 3 is a block diagram showing the electric schematic configuration of the switch device according to an embodiment of the present invention;

FIGS. 4 and 5 are flowcharts of the processing which is performed by a CPU which constitutes the multi-function switch shown in FIG. 3;

FIG. 6 is a view for explaining an example of a click display image; and

FIG. 7 is a view showing an AM radio mode screen which is an example of a subsequent level display image.

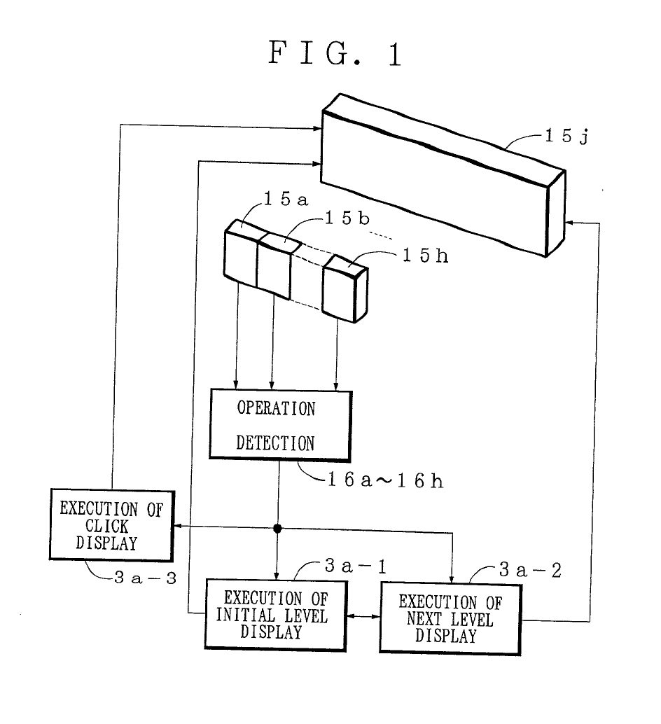

### DESCRITPTION OF THE PREFERRED EMBODIMENTS

Now referring to the drawings, an explanation will be given of an embodiment of this invention.

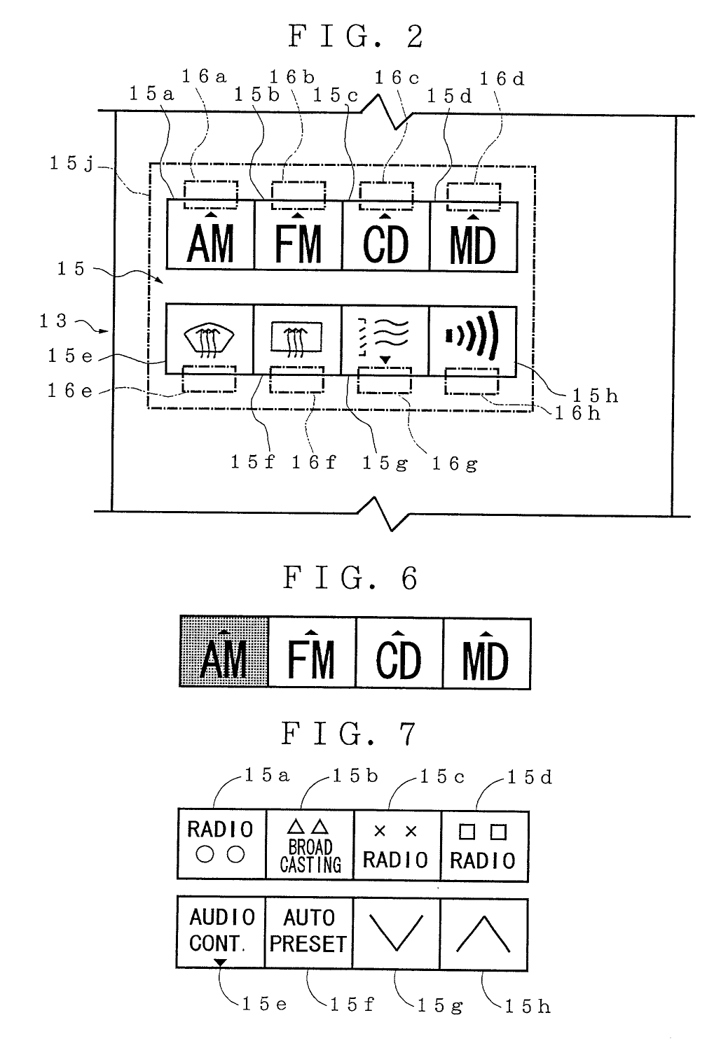

FIG. 2 shows a combination panel 13 which constitutes the multi-function switch device according to the present invention. The combination panel 13 includes a multi-switch section 15 for operating object appliances such as a CD player, an MD player, an AM/FM radio and an air conditioner.

The multi-switch section 15, as seen from FIG. 2, total eight operation buttons 15a-15h are arranged on upper and lower two rows. These operation buttons 15a-15h are made of a light permeable material such as transparent plastic. A liquid crystal display 15j is located, as indicated by a phantom line, located behind the operation buttons 15a-15h.

A plurality of function display images representative of the functions of the operation buttons 15a-15h are displayed on the liquid crystal display 15j. The function display images can be recognized through the corresponding operation buttons 15a-15h, respectively.

The liquid crystal display 15j maybe located not only behind the operation buttons 15a-15h, but also at any optional place. In this case. the light from the displayed image on the liquid crystal display 15j may be led to behind the respective operation buttons 15a-15h through a light conducting means (not shown). Behind the multi-switch section 15, as seen indicated by phantom line in FIG. 2, limit switches 16a-16h for detecting the pressing of the operation buttons 15a-15h are arranged not so as to interfere with the image light from the liquid crystal display 15j.

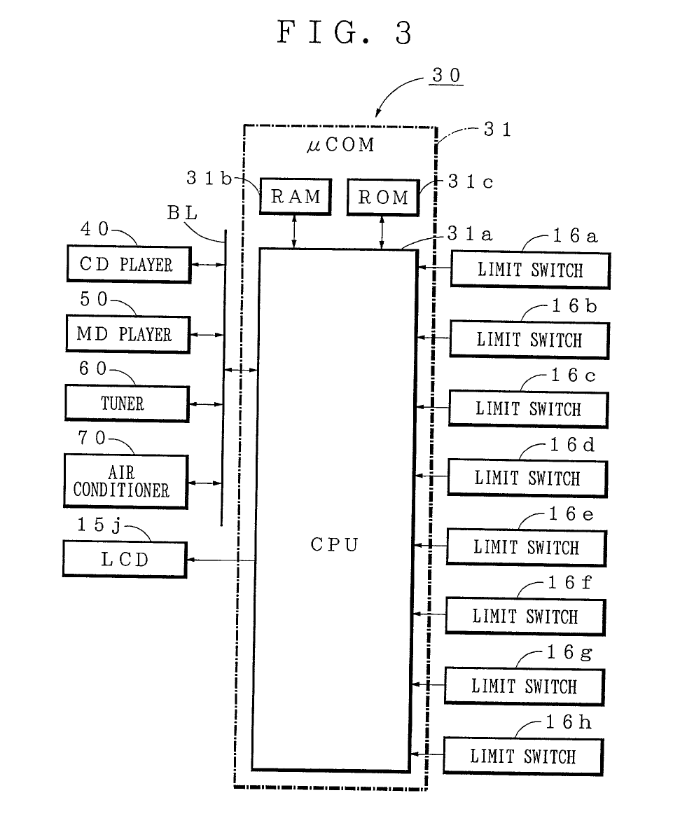

Referring to FIG. 3, an explanation will be given of the schematic electric configuration of the multi-function switch device according to the second embodiment.

As seen from FIG. 3, the switch device 30A includes a microcomputer 31 for controlling the display of the liquid crystal displays 15j described above.

The microcomputer 31 includes a CPU 31a which operates in accordance with a predetermined control program, an RAM 31b which temporarily stores the data necessary to execute the operation by the CPU 31a and an ROM 31c which holds the predetermined program.

The CPU 31a is connected to limit switches 16a-16h. The CPU 31a is connected to a CD player 40, MD player 50, AM/FM tuner 60, TV tuner 65, and air conditioner 70 through a multiplex bus line BL. Thus, the multiplex switch device constitutes a multiplex communication system for executing mutual communication together with the CD player 40, MD player 50, tuner 60 and air conditioner 70.

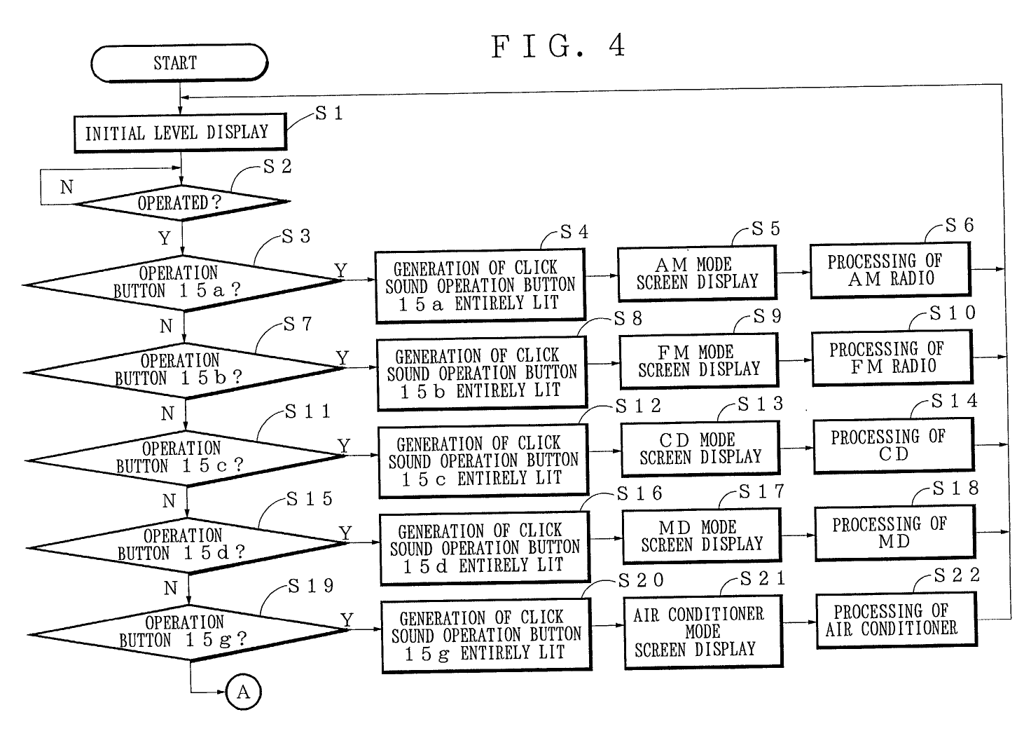

Now referring to the flowchart of FIG. 4 showing the processing procedure of CPU 31a, an explanation will be given of the operation of the multi-function switch device having a configuration described above. First, the CPU 31a starts an operation when e.g. an ignition coil is turned on. In an initial step (not shown), after various areas formed on the RAM 31b has been reset, the processing by the CPU 31a proceeds to a first step S1.

In step S1, the CPU 31a serves as an initial level display executing means which executes the initial level display processing of displaying an initial level display image on the LCD 15j (step S1). On the initial level image, as shown in FIG. 2, the characters of “AM”, “FM”, “CD” and “MD” representative of the appliances to be selected are visually recognized on the four buttons 15a to 15d at the upper stage.

The symbol marks representative of the functions of the selected appliance of “AIR CONDITIONER” are visually recognized on one 15g of the four buttons at the lower stage. In addition to the above characters and symbol mark, other symbol marks of ▴ and ▾ representative of the presence of a next level are visually recognized on the operating buttons 15a to 15d and 15g. The characters of “AM”, “FM”, “CD” and “MD” and the symbol mark representative of the function of the selected appliance of “AIR CONDITIONER” are defined as a specified function display image in claims.

Symbol marks representative of the functions of “defogger”, “heat-rays rear wind heater”, and “traffic information” are visually recognized on the operation buttons 15e, 15f and 15h. The CPU 31a decides whether or not the operation buttons 15a have been operated on the outputs from the limit switches 16a to 16h (step S2).

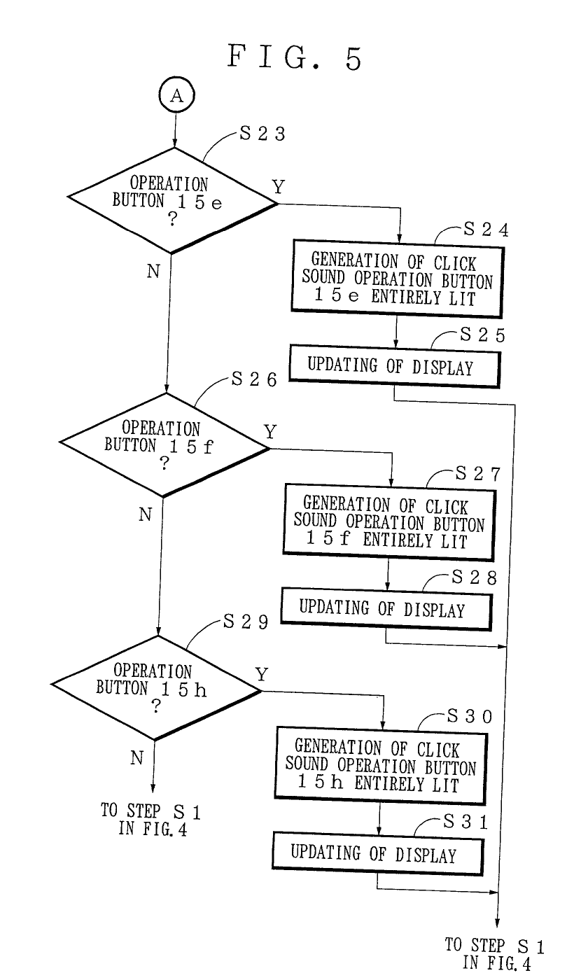

If the operation button 15a has been operated (Y in step S3), click sound is produced. Simultaneously, the CPU 31a serves as a click display executing means which displays, on the LCD 15j, a click display image representative of the fact that the operation button 15a has been operated (step S4). An example of the click display image is shown in FIG. 6 in which the display area corresponding to the operation button 15a is entirely lit for 10 msec.

On the basis the entire lighting of the operation button 15a, a user can recognize that the operation of the operation button 15a has become valid. In addition, since the display area corresponding to the selected operation button 15a is entirely lit for 10 msec, the operation button 15a which has become valid can be easily distinguished from the other operation buttons. Therefore, when the other operation button than the operation button the user has operated is entirely lit, he can visually recognize his erroneous operation. Thereafter, the CPU 31a serves as a next level display executing means which displays an AM mode screen (step S5).

An example of the AM mode screen is shown in FIG. 7. On the four operation buttons 15a-15d at the upper stage, the characters representative of the station names of preset AM broadcasting stations are visually recognized. On the left two operation buttons 15e and 15f at the lower stage, the characters representative of “AUDIO CONT. (audio control)” and “AUTO PRESET (auto preset)” are visually recognized, respectively.

Further, on the right two operation buttons at the lower stage of the AM mode screen, the symbol marks representative of “DOWN of a receiving frequency” and “UP of a receiving frequency” are visually recognized. The symbol marks and characters are defined as an operation function display image in claims, and the AM mode screen is defined as a next level display image in the claims.

Thereafter, the CPU 31a performs AM radio processing (step S6). Specifically, on the basis of the outputs from the limit switches 16a-16h, the CPU 31a performs the recognition on whether or not any of the operation buttons 15a-15h has been operation, click display of entire lighting of the display area corresponding to each of the operated operation buttons 15a-15h for 10 msec and transfer of the signal corresponding to the operating function of the operated operation button 15a-15h to a multiplex bus line BL. When the operation buttons 15a-15h are not operated continuously, the AM radio processing is ended. The processing returns to step S1 in FIG. 4.

On the other hand, when the operation buttons 15b, 15c, the operation button 15b, 15c, 15d or 15g has been operated (Y in steps S7, S11, S15 and S19), the click sound is produced and the display section corresponding to the operation button 15b, 15c, 15d or 15g is entirely lit for 10 msec (steps S8, S12, S16 or S20). Thereafter, the screen of the FM mode, CD mode, MD mode or air conditioner mode is displayed (step S9, S13, S17, S21), the processing of the FM radio, CD, MD or air conditioner is performed (step S10, S14, S18 or S22).

Specifically, on the basis of the outputs from the limit switches 16a-16h, like the processing of the AM radio, the CPU 31a performs the recognition on whether or not any of the operation buttons 15a-15h has been operation, click display of entire lighting of the display area corresponding to each of the operated operation buttons 15a-15h for 10 msec and transfer of the signal corresponding to the operating function of the operated operation button 15a-15h to a multiplex bus line BL. When the operation buttons 15a-15h are not operated continuously, the pertinent processing is ended. The processing process returns to step S1 in FIG. 4.

Referring to the flow chart of FIG. 5, an explanation will be given of the operation when the operation button 15e, 15f or 15h has been pressed. First, if the above operation button 15e, 15f or 15h (Y in step S23, S26 or S29), the click sound is generated and the display section corresponding to the operation button 15e, 15f or 15h is entirely lit for 10 msec (step S24, S27 or S30). Thereafter, the updated display processing will be performed. In the updated display processing, the symbol mark representative of the function of “defogger”, “heat-rays rear wind heater”, or “traffic information” is changed from the mesh-inverted display to the white background normal display, and vice versa (step S25, S28 or S31). Specifically, the mesh-inverted display exhibits the ON state of the “defogger”, “heat-rays rear wind heater”, or “traffic information”, whereas the white background normal display exhibits the OFF state thereof.

When the display is updated form the mesh-inverted display to the white-background normal display, the CPU 31a produces an OFF signal of the defogger, heat-rays rear wind, traffic information toward the multiplex bus line BL. On the other hand, when the display is updated from the white-background normal display, the CPU 31a produces an ON signal thereof. The processing process is returned to step S1 in FIG. 3.

As described above, by changing the screen from the initial level display image to the next level display image, specifying the target appliance and selecting the operation contents of the specified appliance can be carried out using the same operation button 15a-15h. In this way, the function of each button can be sufficiently recognized while the number of the operation buttons and the space for display of the function are reduced.

What is claimed is:

1. A multi-function switch device:
a plurality of operation buttons for selecting operation contents of a target appliance, said operation buttons being made of a light permeable material;
display means on which function images representative of functions of said operation buttons are displayed, said function display images being visually recognized through the corresponding operation buttons;
initial-level-display executing means for displaying an initial level display image containing a specified function display image for specifying said target appliance;
means for detecting the operation of each said operation buttons;
next-level-display executing means for displaying, on said display means, in place of said initial level display image, a next level display image containing an operation function display image for selecting operation contents of said target appliance corresponding to said specified function display image when the said function display image corresponding to said operation button of the detected operation; and
click-display executing means for displaying a click display image indicative of that said operation button is operated when the operation of said operation button is detected by said operation detecting means.

2. A multi-function switch device according to claim 1, wherein said click display executing means displays the click display image permitting the operated operation button to be discriminated.

3. A multi-function switch device according to claim 2, wherein said click display image is visually recognized through the operated operation button.
